(19) United States
(12) Patent Application Publication
(10) Pub. No.: US 2020/0101383 A1
(43) Pub. Date: Apr. 2, 2020

(54) Method and apparatus for recognizing game command

(71) Applicant: Netmarble Corporation, Seoul (KR)

(72) Inventors: Yeong Tae Hwang, Seoul (KR); Jae Woong Shin, Seoul (KR); Je Hyun Nam, Seoul (KR)

(21) Appl. No.: 16/590,586

(22) Filed: Oct. 2, 2019

(30) Foreign Application Priority Data
Oct. 2, 2018 (KR) 10-2018-0117352

(51) Int. Cl. A63F 13/65; A63F 13/215; A63F 13/537

(52) U.S. Cl. CPC A63F 13/65; A63F 13/537; A63F 13/215

(57) ABSTRACT

Disclosed is a game command recognition method and apparatus. The game command recognition apparatus receives a user input of text data or voice data and extracts a game command element associated with a game command from the received user input. The game command recognition apparatus generates game action sequence data using the extracted game command element and game action data and executes the generated game action sequence data.

### TECHNICAL FIELD

The following example embodiments relate to technology for recognizing a game command.

### BACKGROUND ART

A user playing a game proceeds with gameplay by inputting a game command in a specific manner. For example, the user may input an object and input a game command by controlling a mouse or a keyboard or may input the game command through a touch input. In the recent times, controlling a game is becoming complex. Under such a situation, the user needs to define each object and operation method every time the user needs to give a game command. Accordingly, there is a need for a study on a game command system that allows a user to further conveniently input a game command and achieves a relatively low design cost in terms of game development.

### DISCLOSURE

### Technical Solutions

A game command recognition method according to an example embodiment includes receiving a user input of text data or voice data; extracting a game command element associated with a game command from the received user input; generating game action sequence data using the extracted game command element and game action data; and executing the generated game action sequence data.

The game action data may represent a connection relationship between game actions performable on each game screen, may be data that is provided in a form of a graph using a game screen provided to a user as a vertex and using an action of the user as a trunk line, and may be updated together in response to updating of a game program, and game commands executable in a current state may be identified based on graph information represented in the game action data.

The extracting of the game command element may include extracting, from the user input, a word associated with an entity and a motion required to define a game action.

The extracting of the game command element may include further extracting, from the user input, a word associated with a number of iterations required to define the game action.

The extracting of the game command element may include extracting, from the text data, a game command element associated with a game action performed in gameplay when the user input is the text data.

The extracting of the game command element may include extracting, from the voice data, a game command element associated with a game action performed in gameplay when the user input is the voice data.

The extracting of the game command element may include extracting the game command element from the user input using a text-convolutional neural network model.

The extracting of the game command element may include classifying the user input into separate independent game commands when a plurality of game command is included in the received user input, and extracting the game command element from each of the independent game commands.

The generating of the game action sequence data may include determining game actions associated with a game command intended by a user from the game action data based on the extracted game command element, over time.

The generating of the game action sequence data may include generating the game action sequence data using a neural network-based game action sequence data generation model.

The game action sequence data may correspond to the game command included in the text data or the voice data and may represent a set of game actions over time.

The game action data may include information on each of states in gameplay and at least one game action available in each state.

The executing of the game action sequence data may include automatically executing a series of game actions in a sequential manner according to the game action sequence data and displaying the executed game actions on a screen.

A game command recognition apparatus according to an example embodiment may include a text data receiver configured to receive text data input from a user; a processor configured to execute a game action sequence based on the text data in response to the text data being received; and a display configured to output a screen corresponding to the executed game action sequence. The processor may be configured to extract a game command element associated with a game command from the text data and to generate the game action sequence data using the extracted game command element and game action data.

In the game command recognition apparatus, the game action data may include information on each of states in gameplay and at least one game action available in each state, may represent a connection relationship between game actions performable on each game screen, may be data that is provided in a form of a graph using a game screen provided to a user as a vertex and using an action of the user as a trunk line, and may be updated together in response to updating of a game program, and game commands executable in a current state may be identified based on graph information represented in the game action data.

The game command recognition apparatus may further include a voice data receiver configured to receive voice data for a game command input.

The processor may be configured to extract at least one game command element associated with game command data from the voice data and to generate the game action sequence data using the extracted at least one game command element and game action data.

A game command recognition apparatus according to another example embodiment may include a user input receiver configured to receive a user input; a database configured to store a neural network-based game command element extraction model and game action data; and a processor configured to extract a game command element associated with a game command from the user input using the game command element extraction model and to execute game action sequence data corresponding to the game command using the extracted game command element and the game action data.

A game command recognition apparatus according to still another example embodiment may include a processor configured to execute a game action sequence based on text data in response to the text data for game command input being received; and a display configured to output a screen corresponding to the executed game action sequence. The processor may be configured to extract at least one game command element associated with game command data from the text data and to generate the game action sequence data using the extracted at least one game command element and game action data.

### BRIEF DESCRIPTION OF DRAWINGS

FIG. 1 illustrates an overall configuration of a game system according to an example embodiment.

FIG. 2 is a diagram illustrating a configuration of a game command recognition apparatus according to an example embodiment.

FIG. 3 illustrates a game command recognition process according to an example embodiment.

FIG. 4 illustrates an example of recognizing a game command of a text input according to an example embodiment.

FIG. 5 illustrates an example of recognizing a game command of a voice input according to an example embodiment.

FIG. 6 illustrates a process of extracting a game command element according to an example embodiment.

FIG. 7 illustrates an example of extracting a game command element according to an example embodiment.

FIG. 8 illustrates an example of generating game action sequence data according to an example embodiment.

FIGS. 9A, 9B, and 10 illustrate examples of describing game action data according to an example embodiment.

FIG. 11 is a flowchart illustrating a game command recognition method according to an example embodiment.

### BEST MODE FOR CARRYING OUT THE DISCLOSURE

The following structural or functional descriptions of example embodiments described herein are merely intended for the purpose of describing the example embodiments described herein and may be implemented in various forms. Here, the examples are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. Also, when it is mentioned that one component is “connected” or “accessed” to another component, it may be understood that the one component is directly connected or accessed to another component or that still other component is interposed between the two components.

As used herein, the singular forms are intended to include the plural forms as well, unless the context clearly indicates otherwise. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Also, unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, example embodiments will be described in detail with reference to the accompanying drawings. The scope of the right, however, should not be construed as limited to the example embodiments set forth herein. Like reference numerals in the drawings refer to like elements throughout the present disclosure and repetitive description related thereto is omitted.

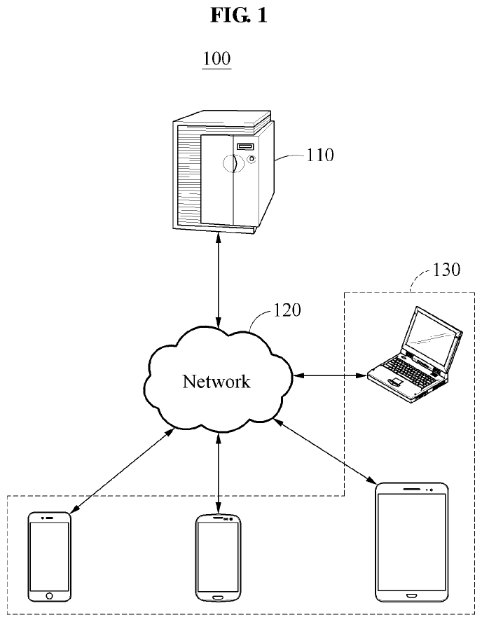

FIG. 1 illustrates an overall configuration of a game system according to an example embodiment.

Referring to FIG. 1, a game system 100 provides a game service to a plurality of user terminals 130 through a server 110. The game system 100 may include the server 110, a network 120, and the plurality of user terminals 130. The server 110 and the plurality of user terminals 130 may communicate with each other over the network 120, for example, the Internet.

The server 110 may perform an authentication procedure for the user terminal 130 that requests an access to execute a game program and may provide the game service to the authenticated user terminal 130.

A user that desires to play a game executes a game application or a game program installed on the user terminal 130 and requests the server 110 for an access. The user terminal 130 may refer to a computing apparatus that enables the user to access a game through an online connection, such as, for example, a cellular phone, a smartphone, a personal computer PC), a laptop, a notebook, a netbook, a tablet, and a personal digital assistant (PDA).

If the user plays a game and, in this instance, a user interface (UI) for controlling the game is complex, the user may experience inconvenience in controlling the game, which may lead to degrading the accessibility of the user to gameplay. Also, with an increase in contents in a game, a user interface becomes complex, which makes it difficult for the user to find a desired game command Meanwhile, in terms of developing a user interface of a game, the user interface needs to be manufactured by manually considering the intent of all of the game commands and accordingly, design cost increases and a relatively large of time is used to design a system for recognizing a game command.

A game command recognition apparatus of the present disclosure may overcome the aforementioned issues. The game command recognition apparatus refers to an apparatus that is configured to recognize and process a game command input from the user when the user plays a game using the user terminal 130. The game command recognition apparatus may be included in the user terminal 130 and thereby operate. According to an example embodiment, in response to a game command input from the user through a text or voice input, the game command recognition apparatus may recognize the input game command and may execute a game control corresponding to the recognized game command. Accordingly, the user may readily play a game without a need to directly execute the game command through the game control. Further, in terms of a game development, a design cost of a game command recognition system may decrease since there is no need to design a separate game command for each stage of the user interface. According to example embodiments, a personalized game command may be configured.

Hereinafter, a configuration and an operation of the game command recognition apparatus are further described. The present disclosure may apply to a PC-based game program or a video console-based game program in addition to the network-based game system 100 of FIG. 1.

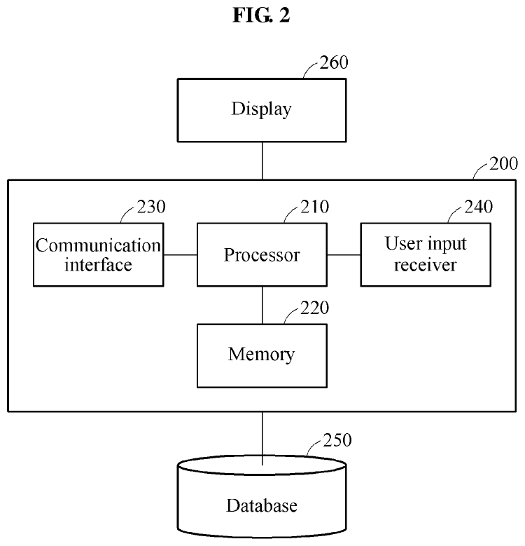

FIG. 2 is a diagram illustrating a configuration of a game command recognition apparatus according to an example embodiment.

A game command recognition apparatus 200 may generate game action sequence data corresponding to a game command in a form of a text or voice by modeling a depth of a game user interface. Referring to FIG. 2, the game command recognition apparatus 200 includes a processor 210, a memory 220, a user input receiver 240, and a communication interface 230. Depending on example embodiments, the game command recognition apparatus 200 may further include at least one of a display 260 and a database 250. The game command recognition apparatus 200 may be included in a user terminal of FIG. 1 and thereby operate.

The user input receiver 240 receives a user input that is input from a user. In one example embodiment, the user input receiver 240 may include a text data receiver and a voice data receiver. The text data receiver receives text data for a game command input and the voice data receiver receives voice data for the game command input. For example, the text data receiver may receive text data through a keyboard input or a touch input and the voice data receiver may receive voice data through a microphone.

The processor 210 executes functions and instructions to be executed in the game command recognition apparatus 200 and controls the overall operation of the game command recognition apparatus 200. The processor 210 may perform at least one of the following operations.

When the text data is received as a game command through the user input receiver 240, the processor 210 executes a game action sequence based on the text data. The processor 210 extracts a game command element associated with the game command from the text data and generates game action sequence data using the extracted game command element and game action data. When the voice data is received as the game command through the user input receiver 240, the processor 210 extracts at least one game command element associated with game command data from the voice data and generates game action sequence data using the extracted at least one game command element and game action data, which is similar to the aforementioned manner. The game command element refers to a constituent element associated with the game command actually intended by the user among constituent elements of the game command input from the user.

In one example embodiment, the processor 210 may extract a game command element associated with a game command from a user input using a neural network-based game command element extraction model. For example, the processor 210 may extract a game command element representing the intent of the game command using ontology-driven natural language processing (NLP) and deep learning.

The processor 210 may automatically generate game action sequence data corresponding to the game command using the extracted game command element and game action data and may automatically execute the generated game action sequence data. Here, a neural network-based game action sequence data generation model may be used to generate the game action sequence data.

The game action data includes information on each of states in gameplay and at least one game action available in each state. The game action data may represent a connection relationship between game actions performable on each game screen based on a depth of a user interface. The game action sequence data corresponds to the game command included in the text data or the voice data and represents a set of game actions over time.

In one example embodiment, when a game command input from the user is a multi-command that includes a plurality of game commands or a conditional command that includes an execution condition, the processor 210 may identify the multi-command and the conditional command from the user input. When the game command input from the user is the multi-command, the processor 210 may decompose the multi-command into separate independent game commands based on a dependency relationship of a sentence and may extract a game command element based on each of the decomposed game commands. In this example, final game action sequence data is in a form in which game action sequence data corresponding to each of the decomposed game commands is combined. When the game command input from the user is the conditional command, the processor 210 may decompose the conditional command into a conditional clause and an imperative clause and then may generate game action sequence data from a game command element extracted from the imperative clause and execute game action sequence data or determine whether to execute the game action sequence data based on content of a condition included in the conditional clause.

The database 250 may store data required for the game command recognition apparatus 200 to recognize the game command input from the user. For example, the database may store a game command element extraction model, game action sequence data, and game action data. The data stored in the database 250 may be updated through a server periodically or if necessary.

The memory 220 may connect to the processor 210 and may store instructions executable by the processor 210, data to be processed by the processor 210, or data processed by the processor 210. The memory 220 may include a non-transitory computer-readable medium, for example, a high speed random access memory and/or a non-volatile computer-readable storage medium, such as, for example, at least one disc storage device, a flash memory device, and other non-volatile solid state memory devices.

The communication interface 230 provides an interface for communication with an external device, for example, a server. The communication interface 230 may communicate with the external device through a wired network or a wireless network.

The display 260 may output a screen corresponding to the game action sequence executed by the processor 210. In response to game action sequence data being executed, the display 260 may automatically display game actions on a game screen provided for the user. For example, the display 260 may be a touchscreen display.

According to the aforementioned technical configuration, there is no need to design a separate game command for each stage of a user interface for play and a design cost of the game command recognition system decreases accordingly. Also, according to an example embodiment, it is possible to readily control gameplay through a text input or a voice input, and to improve a user accessibility and convenience for a game. Also, according to an example embodiment, it is possible to meet a user sensibility through an artificial intelligence (AI) secretary that understands and executes a game command and to configure a personalized game command.

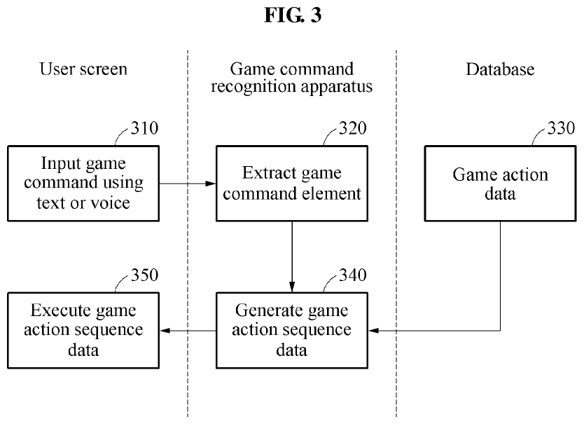

FIG. 3 illustrates a game command recognition process according to an example embodiment.

Referring to FIG. 3, a user inputs a game command desired to execute. In operation 310, the user inputs the game command using a text or voice to execute the game command during gameplay. For example, the user may input the game command in a form of text data through a keyboard or a touch input or may input the game command in a form of voice data through a microphone.

In operation 320, in response to the game command input in the form of the text data or the voice data from the user, the game command recognition apparatus extracts at least one game command element from the input game command. The game command recognition apparatus may extract, from the game command in the form of the text data, a game command element, for example, a game action that the user desires to execute as the game command, an entity required for the game action, and a number of iterations. For example, in response to an input of a game command in a form of text data, the game command recognition apparatus may decompose a text into sematic words and may identify an element to which each of the words corresponds among the game action, the entity, and the number of iterations.

The game command recognition apparatus may tag each of the words based on an identification result. In one example embodiment, the game command recognition apparatus may extract a game command element from the game command using a game command element extraction model, for example, a text convolutional neural network (textCNN) trained to extract a semantic word from input data.

Predefined game action data 330 may be stored in a database. The game action data 330 may be, for example, data that is provided in a form of a graph using a gameplay screen provided to the user as a vertex and using an action, such as a button click, as a trunk line. The game action data 330 may be used to train the game command element extraction model. All of the game commands executable in a current state may be identified based on graph information that is represented based on game action data.

In operation 340, the game command recognition apparatus may generate game action sequence data based on the extracted game command element and the game action data 330. In one example embodiment, the game command recognition apparatus may use ontology-driven NLP to generate the game action sequence data. The game command recognition apparatus may identify, from the game action data, a word and intent of the game command available in a current game situation in which the user inputs the game command. The game command recognition apparatus may determine a flow of game actions from the game action data based on the extracted game command element and may convert the determined flow of game actions to game action sequence data.

In operation 350, the game command recognition apparatus may execute the generated game action sequence data. The game command recognition apparatus may perform the game actions over time based on the game action sequence data and may display a scene of the game actions being performed on a screen. The user may view the game actions being performed to fit the game command input from the user using the text or the voice. The user may verify whether the game actions are being performed according to the intent of the game command input from the user on the screen displayed for the user. As described, the user may conveniently input the game command through the text input or the voice input without a need to control a game for each stage during the gameplay.

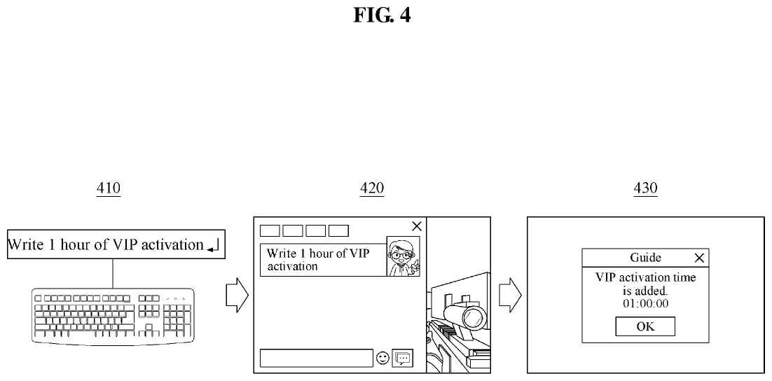

FIG. 4 illustrates an example of recognizing a game command of a text input according to an example embodiment.

Referring to FIG. 4, it is assumed that a user inputs “Write 1 hour of VIP activation” into a game command input box through a keyboard to input a game command during gameplay in operation 410. In operation 420, the input text “Write 1 hour of VIP activation” may be displayed on a game screen. Here, the user may verify the game command in a form of the text input from the user, and it is determined in the gameplay that the user has input the game command of the input text.

A game command recognition apparatus extracts a game command element associated with the game command intended by the user from the text “Write 1 hour of VIP activation” input from the user. For example, the game command recognition apparatus may extract words, “VIP”, “activation”, “1 hour”, and “write” as game command elements. A pretrained neural network-based game command element extraction model may be used to extract the game command elements.

The game command recognition apparatus may estimate sequence of game actions for executing the game command input from the user based on the extracted game command elements, a current game state of the user, and prestored game action data. The game command recognition apparatus may be directed to an item inventory window according to the estimated sequence of game actions and may perform game actions of adding 1 hour to a VIP activation time using an item associated with “VIP activation”, which may be displayed on a game screen in operation 430. The process is automatically performed by the game command recognition apparatus without a direct game control of the user.

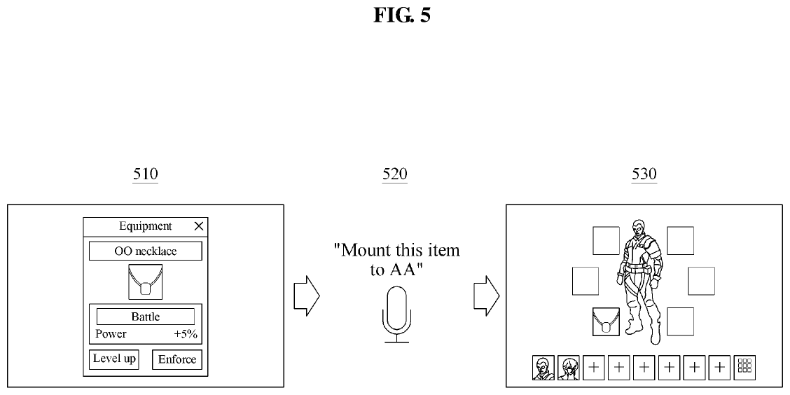

FIG. 5 illustrates an example of recognizing a game command of a voice input according to an example embodiment.

Referring to FIG. 5, it is assumed that a user selects a specific item from an item inventory and desires to mount the selected item to a specific character. In response to the user selecting an item desired to mount, information on the selected item may be displayed on a game screen in operation 510. In operation 520, the user may input a game command through a voice input “Mount this item to AA”. The user may execute a separate game command input function to activate the voice input.

In response to receiving the voice input associated with the game command, a game command recognition apparatus extracts a game command element associated with the game command from the received voice input. For example, the game command recognition apparatus may extract words “this item”, “AA”, and “mount” as game command elements. A pretrained neural network-based game command element extraction model may be used to extract the game command elements.

In one example embodiment, the game command recognition apparatus may convert voice data received through the voice input to text data and may extract a game command element from the corresponding text data. The converted text data may be displayed through the game screen. In this case, the user may verify whether the game command input from the user through the voice input is properly recognized.

The game command recognition apparatus may estimate sequence of game actions for executing the game command input from the user through the voice input based on the extracted game command elements and game action data and may perform the estimated sequence of game actions. Accordingly, a series of a process of mounting the item selected by the user to the character AA may be automatically performed and a final resulting screen may be displayed on the game screen in operation 530.

In the example embodiment, the user may simply control a game through the voice input without a need to perform a series of game control, such as, for example, moving to a character setting screen, selecting the item, and mounting the selected item to the character, to mount the selected item. Accordingly, convenience for controlling a game may be provided to the user and a game accessibility may be improved.

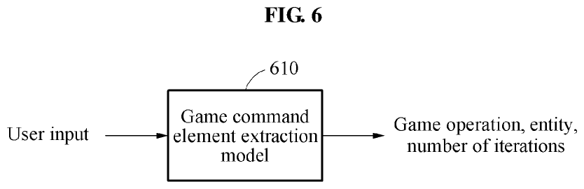

FIG. 6 illustrates a process of extracting a game command element according to an example embodiment.

Referring to FIG. 6, a neural network-based game command extraction model 610 may be used to extract a game command element from a user input. For example, a neural network of a text CNN may be used for the game command extraction model 610. The game command extraction model 610 is trained to output a game command element associated with a game command from input data during a training process. The game command extraction model 610 may output, for example, a game operation, an entity, and a number of iterations of the game operation from the user input. Here, the game operation represents a key word to be executed using the game command and the entity represents a proper noun required for the game action. Using the game command extraction model 610, the game command element included in the user input may be effectively extracted.

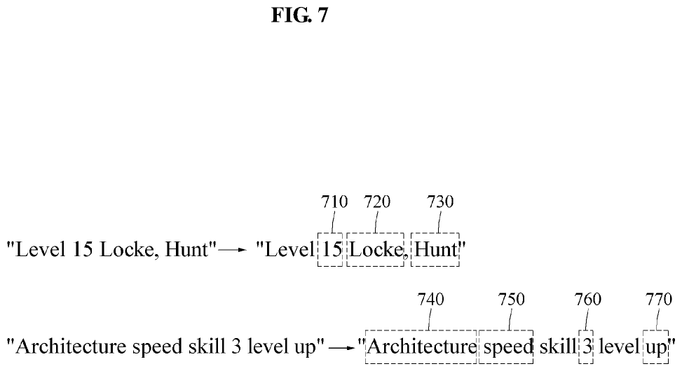

FIG. 7 illustrates an example of extracting a game command element according to an example embodiment.

Referring to FIG. 7, as an example of a user input, it is assumed that text data of “Level 15 Locke, Hunt” is input. As described above, in response to text data input from a user for a game command, important semantic words in the game command may be extracted from “Level 15 Locke, Hunt” as game command elements. For example, “15” 710, “Locke” 720, and “Hunt” 730 may be extracted as game command elements from the text data. Here, “15” 710 and “Locke” 720 may be extracted as entities and “Hunt” 730 may be extracted as a game operation. The extracted words may be tagged based on a type.

As another example of a user input for a game command, it is assumed that text data of “Architecture speed skill 3 level up” is input. In this case, words “architecture” 740, “speed” 750, “3” 760, and “up” 770 may be extracted from the text data of “Architecture speed skill 3 level up” as game command elements. Here, “architecture” 740 and “speed” 750 may be extracted as entities and “up” 770 may be extracted as a game operation. Here, “3” 760 may be extracted as a number of iterations. The extracted words may be tagged based on a type.

The game command element extraction model of FIG. 6 may be used to extract the game command elements.

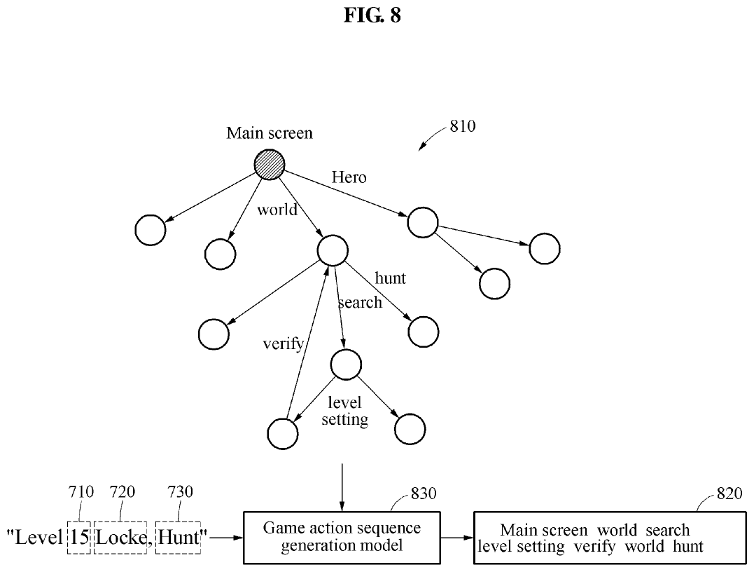

FIG. 8 illustrates an example of generating game action sequence data according to an example embodiment.

Referring to FIG. 8, it is assumed that a screen on which a user is currently playing a game represents a main game screen and “Level 15 Locke, Hunt” is input through a text input or a voice input for a game command. A game command recognition apparatus may extract game command elements, for example, “15” 710, “Locke” 720, and “Hunt” 730, from “Level 15 Locke, Hunt” and may generate game action sequence data 820 using a neural network-based game action sequence data generation model 830. The game command elements, for example, “15” 710, “Locke” 720, and “Hunt” 730, and predefined game action data 810 may be input to the game action sequence data generation model 830, and the game action sequence data generation model 830 may output game action sequence data 820 that is a series of game actions based on the input data. The game action sequence data generation model 830 may convert the game command element extracted from the game command of the user to game action sequence data that is used to execute the game command.

A connection relationship and a contextual relationship between game actions included in the game action sequence data 820 are determined based on the game action data 810. Once the game action sequence data 820 is executed, the game actions are automatically executed in a sequential manner in order of “world→search→level setting→verify→world→hunt” on a current main screen.

An ontology-driven NLP technique may be used during a training process of the game action sequence data generation model 830. Available game command elements and words may be learned from pre-configured game action data and additional training may be performed based on an actual game command.

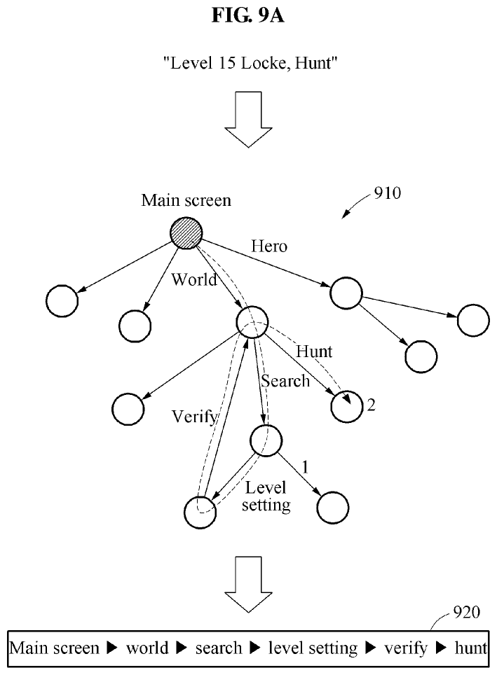

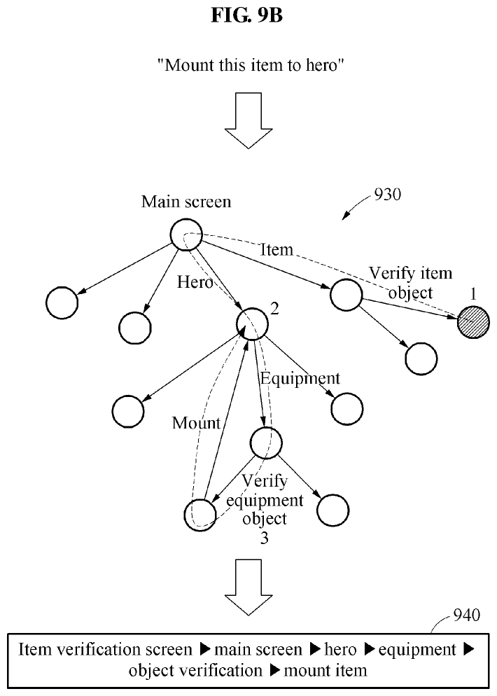

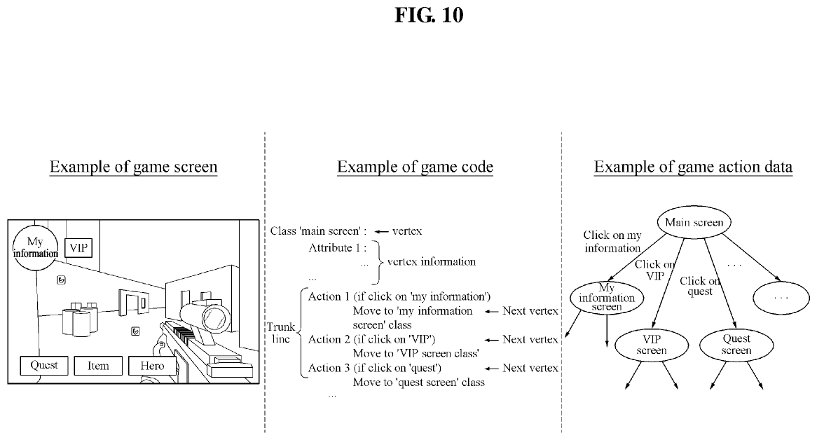

FIGS. 9A, 9B, and 10 illustrate examples of describing game action data according to an example embodiment.

Game action data includes information on states of a game and game actions available in each of the states. Referring to FIGS. 9A, 9B, and 10, the game action data may be represented in a form of a graph using a game screen as a vertex and using an action, for example, a button click, as a trunk line. Here, the vertex represents a current state and the trunk line represents a game action available in the current state. The trunk line is connected to a state or a screen switched from the current state after a game action is performed. Each vertex and trunk link includes information on a characteristic of the current state or a characteristic of the game action. A game screen currently viewed by the user is included in the game action data in a form of the vertex and a current state of the user is a start point in the game action data.

The game action data may be generated in a game development stage and may be stored in a database in a form of a graph or various types of forms. Depending on example embodiments, in response to updating of a game program, the game action data may also be updated. The game action data may be used to train a game action sequence data generation model. Based on the game action data, all of the game commands available in each stage may be identified.

Referring to FIG. 9A, it is assumed that the user inputs a command “Level 15 Locke, Hunt” in a form of a text on a main screen. A game command recognition apparatus may retrieve, from predefined game action data 910, matches of game command elements, for example, 15, Locke, and Hunt, using a main screen as a start point or a reference point and may generate game action sequence data 920 corresponding to the game command. According to the game action sequence data 920, a game action sequence in which “15” is set in a level setting (marked with 1) and “Locke” is selected as an object to hunt on a game screen for hunting (marked with 2) is defined.

Referring to FIG. 9B, as another example, it is assumed that the user inputs a command “Mount this item to a hero” in a form of a text on a main screen. The game command recognition apparatus may retrieve, from game action data 930, matches of game command elements, for example, item, hero, and mount, using a main screen as a start point or a reference point and may generate game action sequence data 940 corresponding to the game command. According to the game action sequence data 940, information on “this item” may be acquired from a current vertex (marked with 1) of the game action data 930, a character of a hero may be selected from a hero screen (marked with 2), and a corresponding item may be selected from an equipment object verification (marked with 3) and then mounted to the hero.

FIG. 10 illustrates examples of a game screen provided to a user, game action data, and a game code corresponding to the game action data according to an example embodiment. The game action data may be represented as a form of a graph and may be configured as a game code, as illustrated in FIG. 10.

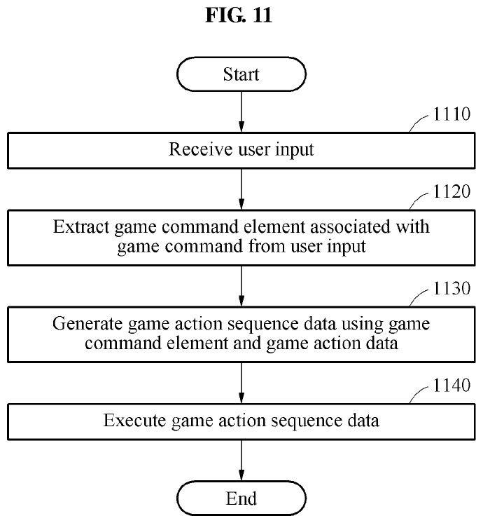

FIG. 11 is a flowchart illustrating a game command recognition method according to an example embodiment. The game command recognition method may be performed by the aforementioned game command recognition apparatus.

Referring to FIG. 11, in operation 1110, the game command recognition apparatus receives a user input that is input from a user for a game command during gameplay. Here, the user input may be text data or voice data.

In operation 1120, the game command recognition apparatus extracts a game command element associated with the game command from the received user input. The game command recognition apparatus may extract, from the user input, a word associated with at least one of an entity, an operation, and a number of iterations required to define a game action. When the user input is text data, the game command recognition apparatus may extract, from the text data, a game command element associated with a game action that is performed during the gameplay. When the user input is voice data, the game command recognition apparatus may extract, from the voice data, a game command element associated with a game action that is performed during the gameplay.

In one example embodiment, the game command recognition apparatus may extract a game command element from the user input using ontology-driven NLP and deep learning. For example, the game command recognition apparatus may extract a game command element from the user input using a text-convolutional neural network model.

In one example embodiment, when a plurality of game commands is included in the received user input, the game command recognition apparatus may classify the user input into separate independent game commands and may extract a game command element from each of the independent game commands.

In operation 1130, the game command recognition apparatus generates game action sequence data using the extracted game command element and game action data. Here, the game action sequence data corresponds to the game command included in the text data or the voice data and represents a set of game actions over time. The game action data includes information on each of states in gameplay and at least one game action available in each of the states. For example, the game action data includes information on a first game action subsequently available based on a current state of the user in gameplay as a reference point in time and a second game action available after the first game action.

The game command recognition apparatus may determine game actions associated with the game command intended by the user from the game action data based on the extracted game command element, over time.

In operation 1140, the game command recognition apparatus executes the generated game action sequence data. The game command recognition apparatus may automatically execute a series of game actions in a sequential manner according to the game action sequence data and may display the executed game actions on a screen.

Descriptions made above with reference to FIGS. 1 to 10 may apply to FIG. 11 and further description is omitted.

The example embodiments described herein may be implemented using a hardware component, a software component and/or a combination thereof. For example, an apparatus, a method, and a component described herein may be implemented using one or more general-purpose or special purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as a parallel processor.

The software may include a computer program, a piece of code, an instruction, or some combination thereof, to independently or collectively instruct or configure the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described hardware devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit are combined in a different manner or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A game command recognition method comprising:
receiving a user input of text data or voice data;
extracting a game command element associated with a game command from the received user input;
generating game action sequence data using the extracted game command element and game action data; and
executing the generated game action sequence data.

2. The game command recognition method of claim 1, wherein the game action data comprises information on each of states in gameplay and at least one game action available in each state.

3. The game command recognition method of claim 2, wherein the game action data represents a connection relationship between game actions performable on each game screen, is data that is provided in a form of a graph using a game screen provided to a user as a vertex and using an action of the user as a trunk line, and is updated together in response to updating of a game program, and
wherein game commands executable in a current state are identified based on graph information represented in the game action data.

4. The game command recognition method of claim 1, wherein the extracting of the game command element comprises extracting, from the user input, a word associated with an entity and a motion required to define a game action.

5. The game command recognition method of claim 4, wherein the extracting of the game command element comprises further extracting, from the user input, a word associated with a number of iterations required to define the game action.

6. The game command recognition method of claim 1, wherein the extracting of the game command element comprises extracting, from the text data, a game command element associated with a game action performed in gameplay when the user input is the text data.

7. The game command recognition method of claim 1, wherein the extracting of the game command element comprises extracting, from the voice data, a game command element associated with a game action performed in gameplay when the user input is the voice data.

8. The game command recognition method of claim 1, wherein the extracting of the game command element comprises extracting the game command element from the user input using a text-convolutional neural network model.

9. The game command recognition method of claim 1, wherein the extracting of the game command element comprises classifying the user input into separate independent game commands when a plurality of game commands is included in the received user input, and extracting the game command element from each of the independent game commands.

10. The game command recognition method of claim 1, wherein the generating of the game action sequence data comprises determining game actions associated with a game command intended by a user from the game action data based on the extracted game command element, over time.

11. The game command recognition method of claim 1, wherein the generating of the game action sequence data comprises generating the game action sequence data using a neural network-based game action sequence data generation model.

12. The game command recognition method of claim 1, wherein the game action sequence data corresponds to the game command included in the text data or the voice data and represents a set of game actions over time.

13. The game command recognition method of claim 1, wherein the game action data comprises information on a first game action subsequently available based on a current state of a user in gameplay as a reference point in time and a second game action available after the first game action.

14. The game command recognition method of claim 1, wherein the executing of the game action sequence data comprises automatically executing a series of game actions in a sequential manner according to the game action sequence data and displaying the executed game actions on a screen.

15. A non-transitory computer-readable recording medium storing a program to perform the method of claim 1.

16. A game command recognition apparatus comprising:
a text data receiver configured to receive text data input from a user;
a processor configured to execute a game action sequence based on the text data in response to the text data being received; and
a display configured to output a screen corresponding to the executed game action sequence,
wherein the processor is configured to extract a game command element associated with a game command from the text data and to generate the game action sequence data using the extracted game command element and game action data.

17. The game command recognition apparatus of claim 16, wherein the game action data comprises information on each of states in gameplay and at least one game action available in each state, represents a connection relationship between game actions performable on each game screen, is data that is provided in a form of a graph using a game screen provided to a user as a vertex and using an action of the user as a trunk line, and is updated together in response to updating of a game program, and
wherein game commands executable in a current state are identified based on graph information represented in the game action data.

18. The game command recognition apparatus of claim 15, further comprising:
a voice data receiver configured to receive voice data for a game command input,
wherein the processor is configured to extract at least one game command element associated with game command data from the voice data and to generate the game action sequence data using the extracted at least one game command element and game action data.

19. A game command recognition apparatus comprising:
a user input receiver configured to receive a user input;
a database configured to store a neural network-based game command element extraction model and game action data; and
a processor configured to extract a game command element associated with a game command from the user input using the game command element extraction model and to execute game action sequence data corresponding to the game command using the extracted game command element and the game action data.

20. The game command recognition apparatus of claim 19, wherein the game action data comprises information on each of states in gameplay and at least one game action available in each state, represents a connection relationship between game actions performable on each game screen, is data that is provided in a form of a graph using a game screen provided to a user as a vertex and using an action of the user as a trunk line, and is updated together in response to updating of a game program, and wherein game commands executable in a current state are identified based on graph information represented in the game action data.
